(19) United States
(12) Patent Application Publication
(10) Pub. No.: US 2009/0152370 A1
(43) Pub. Date: Jun. 18, 2009

(54) Chimney device and methods of using it to fight global warming, produce water precipitation and produce electricity

(76) Inventor: Michael Gregory Pesochinsky, Wayne, NJ (US)

Correspondence Address: M. Pesochinsky, 9 Warner Way, Wayne, NJ, 07470, US

(21) Appl. No.: 12/316,625

(22) Filed: Dec. 15, 2008

Related U.S. Application Data
(60) Provisional application No. 61/008,069, filed on Dec. 18, 2007.

(51) Int. Cl. A01G 15/00

(52) U.S. Cl. 239/2.1

(57) ABSTRACT

A method of cooling the Earth atmosphere along with inducing water precipitation and producing electricity by providing a super tall chimney 1000 m to 10000 m tall coupled with electric wind turbines, by allowing warm air to move up to chimney.

### CROSS REFERENCES TO RELATED APPLICATION

This application claims the benefit of Provisional Patent Application U.S. 61/008,069, filed on Dec. 18, 2007 by the present inventor.

### FEDERALLY SPONSORED RESEARCH

Not Applicable

### SEQUENCE LISTING OR PROGRAM

Not Applicable

### FIELD OF THE INVENTION

The invention relates generally to the field of atmospheric climate control, fresh water production and alternative energy sources fields, and particularly to providing a chimney device configured to control atmospheric climate and produce energy.

### BACKGROUND OF THE INVENTION

The biggest challenge of the 21st century civilization is global warming. As result of this change in our planet atmosphere, humankind experiences many problems such as rise of Ocean water level, extreme weather patterns, loss of biodiversity. To resolve those problems we need either to reduce CO₂ concentrations in our atmosphere or find a way to cool our atmosphere.

First approach can be achieved by shifting to clean alternative energy sources not based on burning fossil fuels. Solar updraft tower is a particularly interesting approach. The solar updraft tower is a renewable-energy power plant. Air is heated in a very large circular greenhouse-like structure, and the resulting convection causes the air to rise and escape through a tall tower. The moving air drives turbines, which produce electricity. A research prototype operated in Spain in the 1980s¹. While the tower produces clean energy it has a substantial defect, because it requires building the greenhouse structure, which by itself increases amount of heat trapped in the Earth atmosphere and therefore contributes to the global warming. 1. Solar updraft tower, http://en.wikipedia.org/wik/Solar_updraft_tower

Next, an increase of CO2 uptake by plants can remedy the problem. Some scientists suggest changing of the ocean chemistry to induce algae growth and consequently CO2 uptake². 2. Crazy-Sounding Ideas May Help Combat Global Warming, http://www.foxnews.com/story/0,2933,259590,00.html

Second approach is to reduce the amount of heat trapped in the Earth atmosphere. There are number of proposals exist on this aspect². They include:
shooting tons of dust into atmosphere to block sun radiation
placing different types of shades like huge artificial trees or flying objects to block sun radiation

All of the above approaches are expensive and risky solution to the problem of global warming. Moreover, there is a lot of skepticism about their feasibility. The problem is very acute and requires urgent attention.

### SUMMARY OF THE INVENTION

In accordance with the invention a chimney device was developed. The chimney comprises a pipe standing on a base. The pipe is at least 1000 m tall. In fact, the taller it is the better the efficiency of the chimney, so it can be limited only by practicability and structural stability consideration. In the lower section of the pipe there are openings. Alternatively or concurrently, there can be channels in the base connecting the chimney inside and the outside atmosphere.

The chimney operates by allowing warm air from the Earth surface to be sucked in and moved upwards through the chimney due to the natural draft of airflow. As result, large quantities of air are lifted to the height of the chimney and expelled into upper atmosphere. That transport of warm air to the higher altitude causes the whole Earth atmosphere to loose more heat then it would loose otherwise, thus reducing global warming effect.

When the air is expelled from the chimney, it is oversaturated with water vapors. Therefore, when it mixes with surrounding air and cools down, water naturally precipitates causing precipitation in the surrounding area. The amount of that precipitation can be substantial enough to sustain agriculture in areas such as deserts.

Since the air is flowing through the chimney at very high speed, the wind energy can be harvested by attaching electrical wind turbines to the openings in the chimney or base channels. Alternatively or concurrently, the electrical wind turbines can be positioned inside the chimney itself. The resulting energy production can be very high.

### BRIEF DESCRIPTION OF THE DRAWINGS

The advantages, nature and various additional features of the invention will appear more fully upon consideration of the illustrative embodiments now to be described in detail in connection with the accompanying drawings. In the drawings:

FIG. 1 illustrates a chimney device according to the invention with openings in the lower section of the pipe.

FIG. 2 illustrates a chimney device according to the invention with openings in the lower section of the pipe, wherein the openings are coupled with electrical wind turbines

FIG. 3 illustrates a chimney device according to the invention with openings in the lower section of the pipe, wherein the electrical wind turbines are positioned on the inner side of the body of the pipe.

FIG. 4 illustrates a chimney device according to the invention with plurality of channels going through the base.

FIG. 5 illustrates a chimney device according to the invention with plurality of channels going through the base, wherein the channels are coupled with electrical wind turbines

FIG. 6 illustrates a chimney device according to the invention with plurality of channels going through the base, wherein the electrical wind turbines are positioned on the inner side of the body of the pipe.

FIG. 7 illustrates a chimney device according to the invention placed inside a mountain, with air channels going through the base of the mountain.

FIG. 8 illustrates a chimney device according to the invention chimney constructed on the mountain side to support the structure.

FIG. 9 illustrates a chimney device according to the invention with plurality of channels going through the base wherein multiple air pipes connected to the channels.

It is to be understood that these drawings are for purposes of illustrating the concepts of the invention and, except for the graphical illustration, are not to scale.

### DETAILED DESCRIPTION

In accordance with the invention chimney device was developed. The most important aspect of the chimney is its height. The chimney must be at least 1000 m tall and preferably a lot taller up to 10,000 m. The reason for that limitation is the principle of work of the chimney and its objective.

The principle of work of the chimney is using property of hot air to rise by natural air draft. The calculation show that the higher the chimney the more efficient it is. For example, if the chimney is 1000 m tall, the air will travel through the chimney at the speed of 27 m/sec. However, if the height is 10,000 m then the speed of air traveling will be roughly ten times faster. Besides the chimney's height, the temperature at the base and at the upper end of chimney will be significant factors. The bigger the difference between those two temperatures, the stronger is the air draft through the chimney. Since the air temperature falls roughly by 10° C. with every 1000 m of altitude, it provides practically an unlimited supply of energy.

The chimney has the following objectives: to cool the Earth Atmosphere, Produce sustainable water precipitation and Produce Electricity. All three objectives can be achieved on the same chimney.

1. Cooling the Earth Atmosphere by Facilitation of Air Convection.
Normally, heat radiation comes from sun and then it is partially absorbed by the atmosphere while it travels through. Then the heat radiation is partially absorbed by the planet surface. The other part of heat radiation is reflected back into space. The reflected heat travels back through the atmosphere and naturally, part of it is again absorbed by the atmosphere. The chimney will facilitate air convection by bringing masses of warm air at high altitude, resulting in the warm air coming out of the chimney exit. When the heat from the air will radiate out it will be already at high altitude thus the amount of energy reabsorbed by the atmosphere will be less, because there will be thinner layer of air for heat to travel through. Therefore, more heat will be leaving the atmosphere thus reducing the atmosphere temperature.

2. Production of Sustainable Water Precipitation.
When the warm air is expelled from the chimney, it is oversaturated with water vapors. Therefore, when it mixes with surrounding air and cools down, water naturally precipitates causing precipitation in the surrounding area. The high winds at high altitude will be carrying the newly formed clouds to long distances away before pouring out as rain. That will allow covering of a large area with additional rain, which it would not receive otherwise. The phenomenon will be especially beneficial in arid hot places because the amount of the precipitation can be substantial enough to sustain agriculture in the desert areas.

3. Production of Electricity.
Since the air is flowing through the chimney at very high speed, the wind energy can be harvested by attaching electrical wind turbines to the openings in the chimney or base channels. Alternatively or concurrently, the electrical wind turbines can be positioned inside the chimney itself. The resulting electro energy production can be very high on the industrial level.

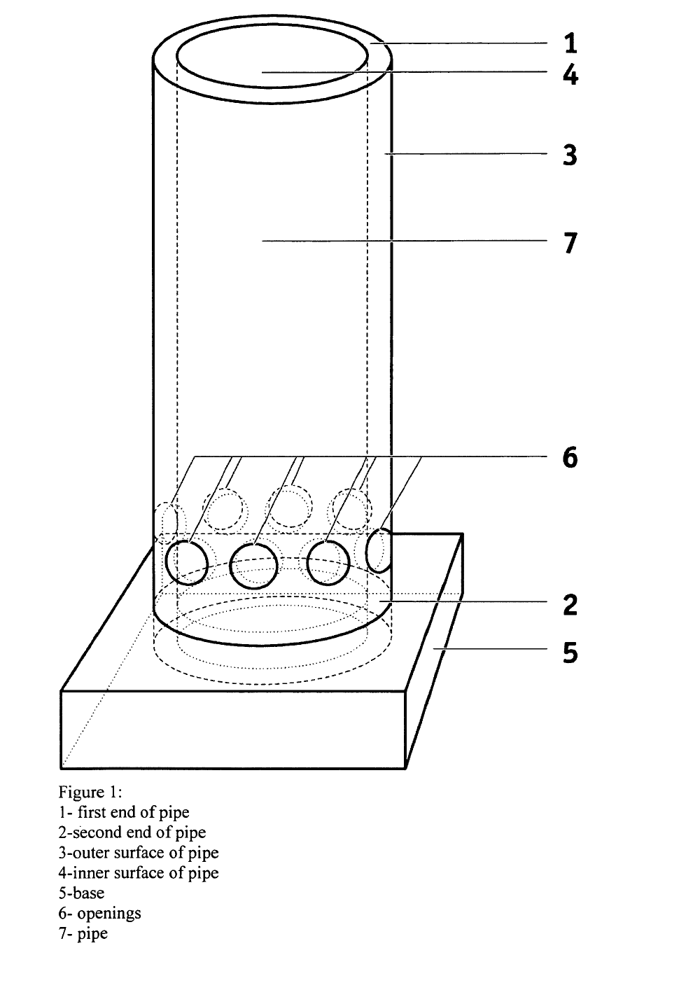

There are two possible exemplary embodiments for the chimney. In both cases the chimney comprising a pipe which stands on a base. The first exemplary embodiment is best viewed in FIG. 1. It shows: a chimney comprising a pipe(7) having a first end(1), a second end(2), and a body, the body having an inner(4) and a outer(3) surface, the body further having a plurality of openings(6) near the second end(2), wherein the first end(1) is open and positioned above the second end(2) and it is fixed on a base(5).

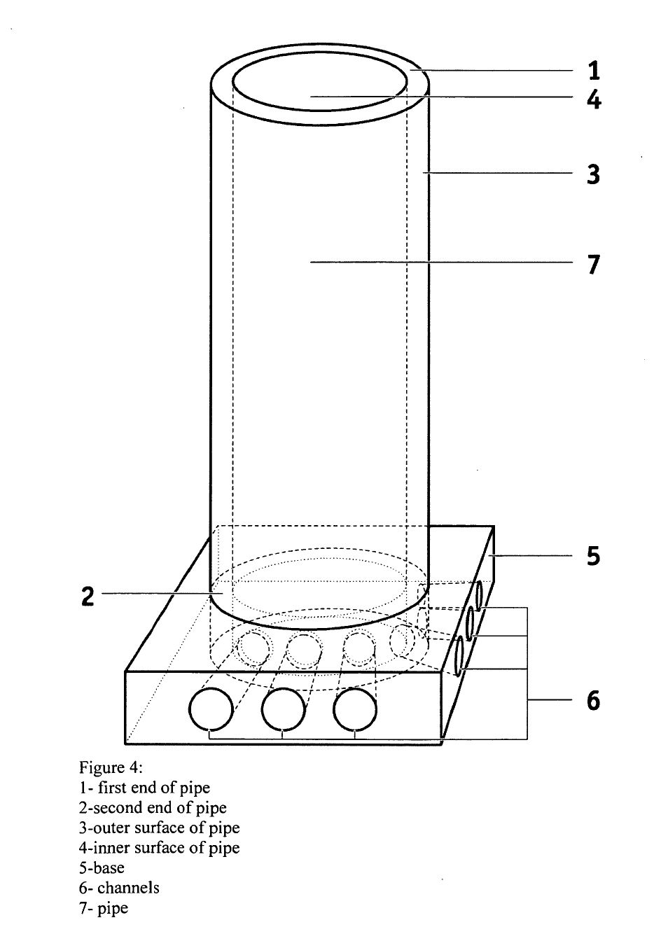

The second exemplary embodiment is best viewed in FIG. 4. It shows: a chimney comprising a pipe(7) having a first end(1), a second end(2), and a body, the body having an inner(4) and an outer(3) surface; a plurality of channels(6) between the outer surface of base(5) and the inner surface of base(5) The channels in the base are connecting the inside of the pipe(7) and the outside atmosphere. The base can take any shape to assure the structural stability of the chimney. The channels in the base can take any direction or shape to accommodate structural stability of the chimney or aerodynamic requirements for the airflow.

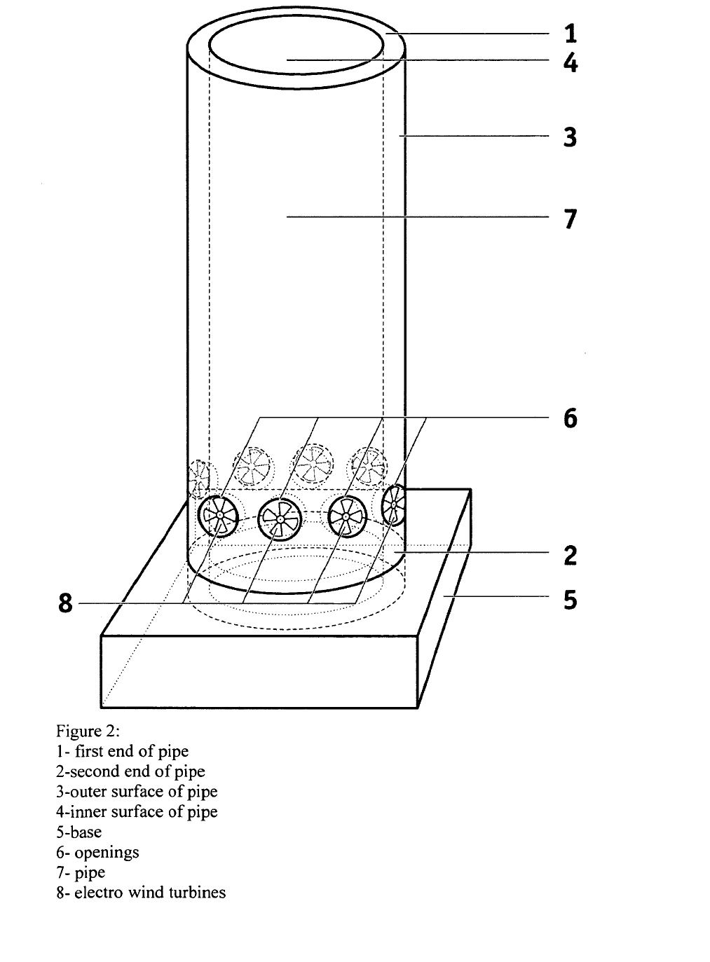

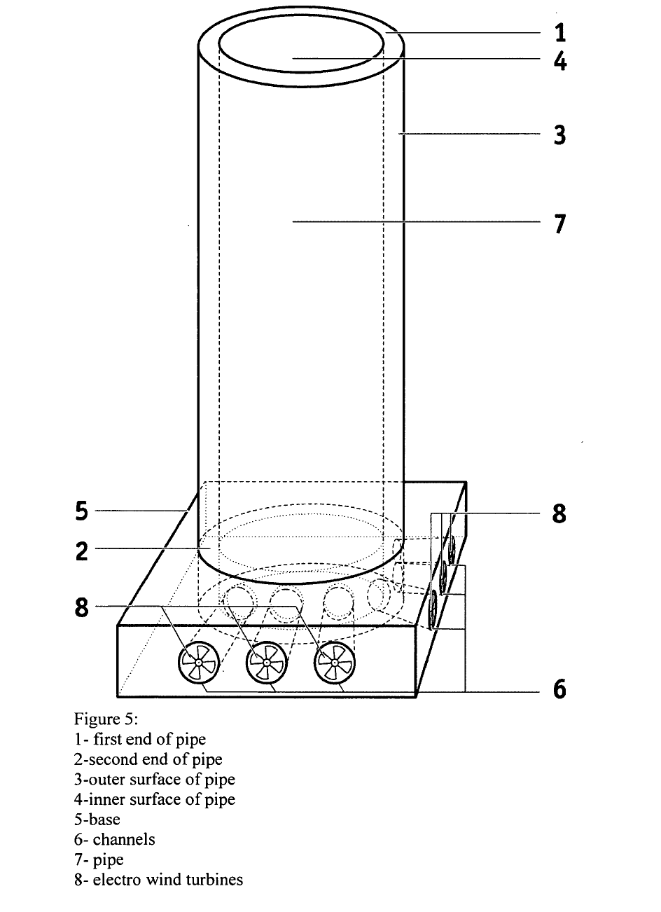

In order to harvest electricity from the airflow electrical wind turbines need to be attached to the openings in the chimney or base channels as it is shown on FIGS. 2 and 5.

FIG. 2 shows a chimney comprising a pipe(7) having a first end(1), a second end(2), and a body, the body having an inner(4) and a outer(3) surface, the body further having a plurality of openings(6) near the second end(2), wherein the first end(1) is open and positioned above the second end(2) and it is fixed on a base(5). The electrical wind turbines(8) are attached to the openings(6) in the chimney.

FIG. 5 shows a chimney comprising a pipe(7) having a first end(1), a second end(2), and a body, the body having an inner(4) and an outer(3) surface; a plurality of channels(6) between the outer surface of base(5) and the inner surface of base(5) The channels in the base are connecting the inside of the pipe(7) and the outside atmosphere. The electrical wind turbines(8) are attached to the channels(6) in the base(5).

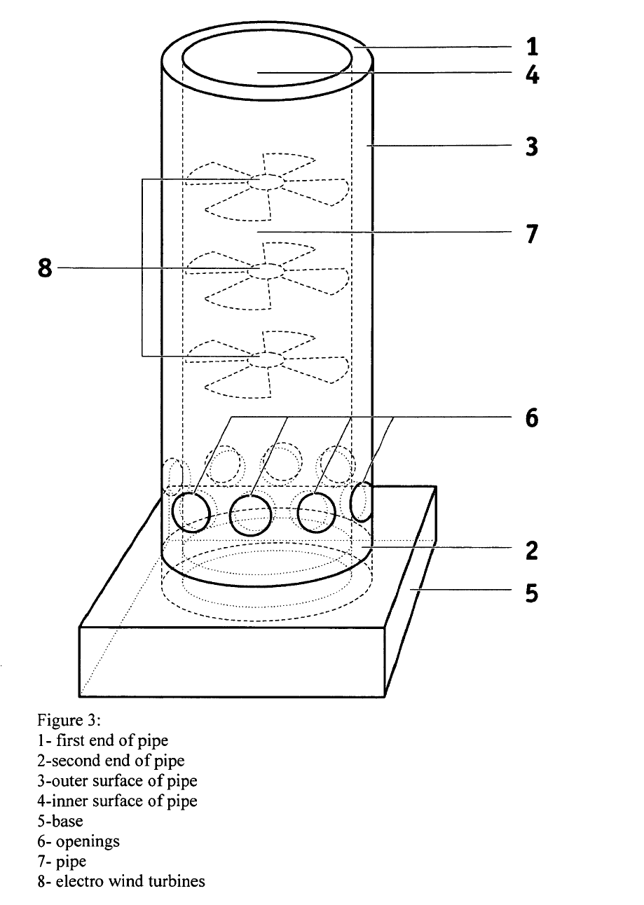

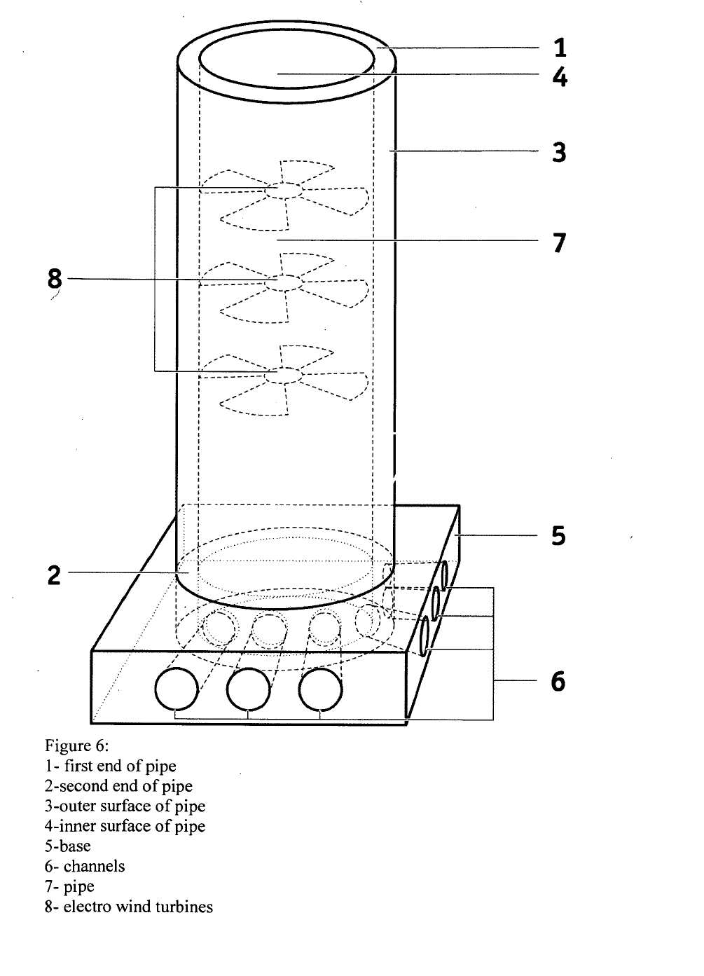

Alternatively or concurrently, the electrical wind turbines can be positioned inside the chimney itself as it is shown in FIG. 3 and FIG. 6.

FIG. 3 shows a chimney comprising a pipe(7) having a first end(1), a second end(2), and a body, the body having an inner(4) and a outer(3) surface, the body further having a plurality of openings(6) near the second end(2), wherein the first end(1) is open and positioned above the second end(2) and it is fixed on a base(5). The electrical wind turbines(8) are positioned inside the pipe(7).

FIG. 6 shows a chimney comprising a pipe(7) having a first end(1), a second end(2), and a body, the body having an inner(4) and an outer(3) surface; a plurality of channels(6) between the outer surface of base(5) and the inner surface of base(5) The channels in the base are connecting the inside of the pipe(7) and the outside atmosphere. The electrical wind turbines(8) are positioned inside the pipe(7).

It needs to be noticed that the pipe of the chimney does not have to be exactly perpendicular to the base. It can be under some angle to accommodate structural requirements. However, such correlation will reduce the chimney efficiency.

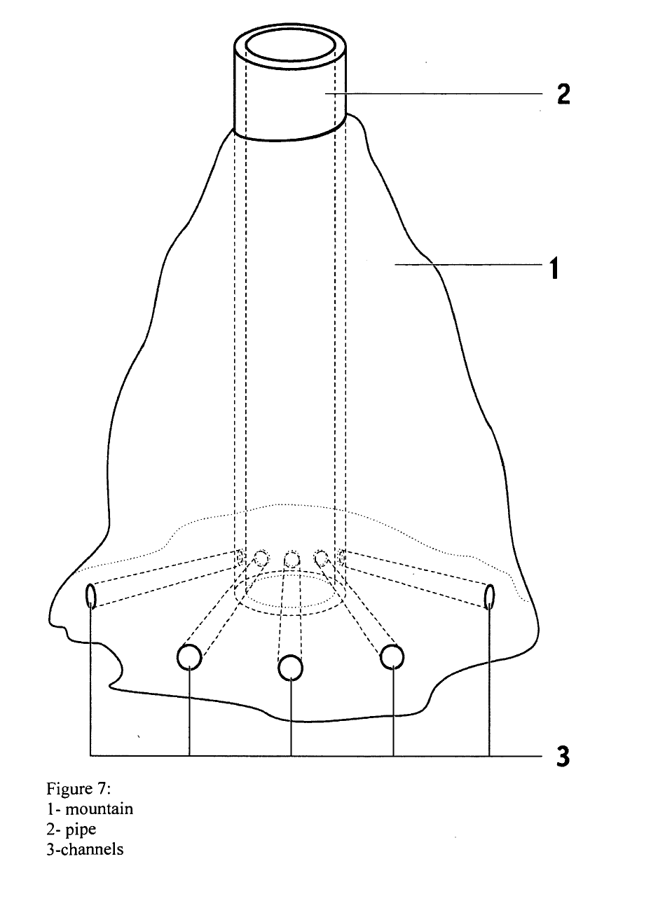

Chimney may be constructed with support of natural landscape features such as mountains or canyons. As best viewed in FIG. 7, the chimney pipe(2) can be placed inside a mountain(1), with air channels(3) going through the base of the mountain.

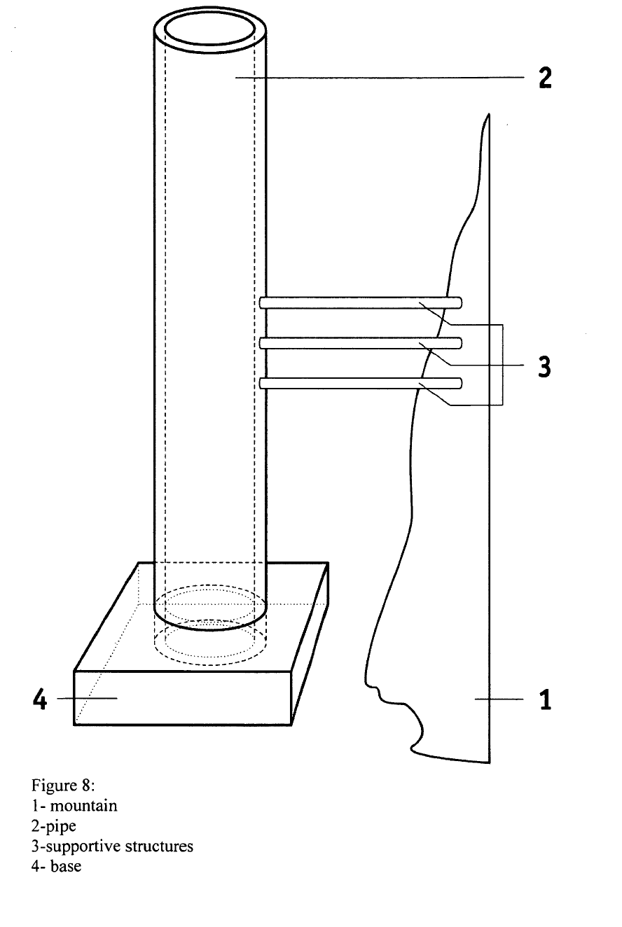

The chimney can be constructed on the mountainside to support the structure as best viewed in FIG. 8, wherein chimney pipe(2) mounted on base(4) and supported by mountain(1) via supportive structures(3)

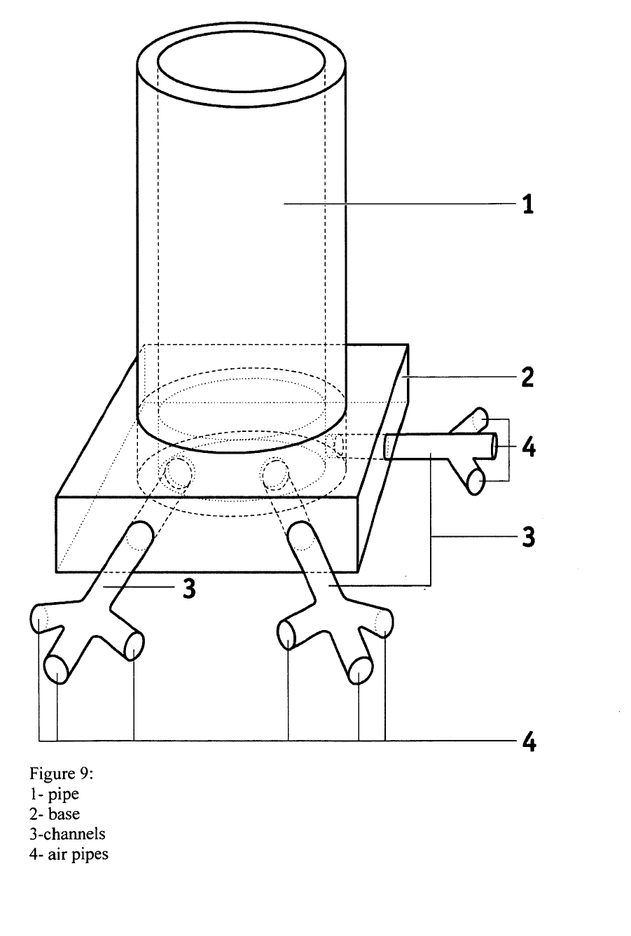

In order to reduce the wind in surrounding are the chimney base may be extended. In one embodiment, multiple air pipes(4) can be connected to the channels(3) on the sides of the base(2) as best viewed in FIG. 9. Keeping winds low in the area can be achieved by spreading those pipes, with openings substantially removed from the chimney. The turbines can be mounted inside those pipes, which will allow easy access for maintenance. In addition, because plurality of such pipes will have large area of combine opening the airflow within each individual pipe will be low in compare to the one inside chimney's main pipe(1), thus making maintenance more convenient. By opening/closing those pipes, the combine air flow through the chimney can be regulated.

Example of chimney device was calculated for the following conditions: chimney 5000 m high and 1000 m in diameter, wherein the temperature of air at the bottom is 30° C. and at 5000 m it is −20° C.

According to calculations such chimney expected to produce the natural draft of air flow at the speed of 139.2 m/s³. That translates into 109,357,369 m³/s of air going through the chimney³. At the air density equal 1.164 kg/m³ at 30° C.⁴, that means 127,292,000 kg/s of air going through the chimney. 3. Natural Draft Air Flow and Velocity Calculator. http://www.engineeringtoolbox.com/natural-draught-ventilation-d_{—}122.html4. Air-Altitude, Density and Specific Volume http://www.engineeringtoolbox.com/air-altitude-density-volume-d_{—}195.html

We can foresee roughly 800 tons of precipitation dispersed in surrounding areas every second. Depending on the wind strength and direction such system will ensure reliable source of water covering substantial areas (hundreds of square kilometers). Overall, it can produce ˜70 mln. tons of water precipitation every day.

Just ten chimneys like this will be enough to offset the effect of global warming

Finally, the amount of electricity harvested will greatly depend on the type of turbines used and how they are positioned. Assuming that the whole air flow going throw the chimney is used we can project 327,786 Mega Watt per second capacity⁵. 5. How Can I Calculate the Amount of Power Available at a Given Wind Speed?http://www.awea.org/faq/windpower.html

What is claimed is:

1. A method of cooling the Earth atmosphere comprising the steps of:
providing a chimney comprising a pipe having a first end, a second end, and a body, the body having an inner and a outer surface, the body further having a plurality of openings near the second end;
allowing warm air to move up the chimney;
wherein the first end is open and positioned above the second end;
wherein the second end is fixed on a base; and
wherein the distance between the first end and second end of the pipe is between 1000 m and 10000 m.

2. A method of claim 1 wherein the plurality of openings near the second end is coupled with a plurality of channels, the plurality of channels connecting the outer surface of the base and plurality of openings near the second end.

3. A method of inducing precipitation comprising the steps of:
providing a chimney comprising a pipe having a first end, a second end, and a body, the body having an inner and a outer surface, the body further having a plurality of openings near the second end;
allowing warm air to move up the chimney;
allowing the warm air exiting the chimney to cool in the surrounding atmosphere to condensate into precipitation;
wherein the first end is open and positioned above the second end;
wherein the second end is fixed on a base; and
wherein the distance between the first end and second end of the pipe is between 1000 m and 10000 m.

4. A method of claim 3 wherein the plurality of openings near the second end is coupled with a plurality of channels, the plurality of channels connecting the outer surface of the base and plurality of openings near the second end.

5. A method of producing electricity comprising:
providing a chimney comprising a pipe having a first end, a second end, and a body, the body having an inner and a outer surface, the body further having a plurality of openings near the second end;
wherein the chimney is coupled with one or more electrical wind turbine; and
allowing warm air to move up the chimney;
exposing the electrical wind turbines to the air movement;
producing electricity in the electrical wind turbines;
wherein the first end is open and positioned above the second end;
wherein the second end is fixed on a base; and
wherein the distance between the first end and second end of the pipe is between 1000 m and 10000 m.

6. A method of claim 5 wherein the plurality of openings near the second end is coupled with a plurality of channels, the plurality of channels connecting the outer surface of the base and plurality of openings near the second end.
